(19) United States
(12) Patent Application Publication
(10) Pub. No.: US 2019/0129005 A1
(43) Pub. Date: May 2, 2019

(54) INVENTORY/FILL DETECTION RADAR SYSTEM

(71) Applicants: James Logan, Candia, NH (US); John T. Apostolos, Lyndeborough, NH (US); William Mouyos, Windham, NH (US); Jeffrey Duke Logan, Somerville, MA (US); Paul Gili, Mason, NH (US)

(72) Inventors: James Logan, Candia, NH (US); John T. Apostolos, Lyndeborough, NH (US); William Mouyos, Windham, NH (US); Jeffrey Duke Logan, Somerville, MA (US); Paul Gili, Mason, NH (US)

(21) Appl. No.: 16/037,604

(22) Filed: Jul. 17, 2018

Related U.S. Application Data
(60) Provisional application No. 62/533,493, filed on Jul. 17, 2017.

(51) Int. Cl. G01S 7/41; G01N 23/203; G01S 13/89; G01S 13/88; G01N 22/00

(52) U.S. Cl. CPC G01S 7/412; G01N 23/203; G01N 22/00; G01S 13/887; G01S 13/89

(57) ABSTRACT

A radar system is described that uses microwave emitters to sense, classify and determine the contents of small containers that are used in transport or storage. The characteristics of these contents can be determined by orienting a set of microwave emitters and receptors around the containers. Correlating the results of the data obtained from the emitters and receptors, the volume and type of the contents of the containers can be determined.

### BACKGROUND OF INVENTION

### Field of the Invention

The present invention is directed to remote sensing and object classification, specifically using microwave emitters and receptors to determine the characteristics of contents inside a container.

### Description of the Related Art

The previous and current methods of remote sensing and object classification is to measure the scattered microwave fields, and knowing (or assuming) the incident field, calculate the scatterer's shape and material based on the received fields. Present methods work backwards using the Fourier transform relationship between current density on the object of interest and radiated field received by the sensor antennas. The current density is assumed due to scattering of the incident field from the transmit antennas. The final product is an image of the object of interest formed by plotting the current density in 3-D space. This process is tedious and requires much processing at microwave frequencies. Due to undesired reflections from many undesired scatterers, the assumptions are not exact, which results in noise that must be filtered out.

### SUMMARY OF THE INVENTION

A system, apparatus, and method for determining the quantity and type of contents of small containers placed on pallets and other storage locations using Microwave radiation.

### BRIEF DESCRIPTION OF FIGURES

FIG. 1 is a drawing of microwave detection system and apparatus.

FIG. 2 is a drawing of microwave detection block diagram.

FIG. 3 is a drawing of the sequence of operations.

FIG. 4 is a drawing of Full 3D E-M simulation of partial pallet radar system, in 2.5 GHz ISM band.

FIG. 5 is a drawing of Method of determining number of beverage cans in container, or on shelf.

FIG. 6 is a drawing of Antenna Pattern Simulation (5.8 GHz ISM band).

FIG. 7 is a drawing of sharing a single transmitter and receiver between many antennas.

FIG. 8 is a drawing of sealed container radar device placement.

FIG. 9 is a drawing of portable toilet embodiment.

FIG. 10 is a drawing of indoor janitorial supplies embodiment.

### DETAILED DESCRIPTION OF THE INVENTION

With inventory control, the quantity and type of contents of material placed on pallets and other storage locations is often unknown or time consuming to determine. The quantity or type of contents may be unknown due to lost or inaccurate documentation, the documentation being expensive or time consuming to locate, or even in the wrong language. The quantity of product may be an unknown variable simply due to the purchasing or pilferage by customers. Recent advances in applications of microwave radar imaging have made an inexpensive solution to this problem available. These advances are in the specific areas of Microwave Tomography¹, Ground Penetrating Radar², and Through-the-Wall Human Detection radars' for security. The remote sensing is facilitated by WIFI network adaptability. ¹ Lluís Jofre; Antoni Broquetas et al: “UWB Tomographic Radar Imaging of Penetrable and Impenetrable Objects” Proceedings of the IEEE 2009, Volume 97, Issue 2; Pages: 451-464.² N. Khalid; S. Z. Ibrahim; M. N. A. Karim: “Directional and wideband antenna for ground penetrating radar (GPR) applications” 2016 3rd International Conference on Electronic Design (ICED 2016) Pages: 203-206³ Ashith Kumar; Qilian Liang; Zhuo Li; Baoju Zhang; Xiaorong Wu: “Experimental study of through-wall human being detection using ultra-wideband (UWB) radar” 2012 IEEE Globecom Workshops Pages: 1455-1459.

Microwave radiation is like light in many ways except that it has the ability to pass through dielectric material such as wood, plastic, fiberglass, etc., which block light and prevent viewing the contents of boxes made of that material. By properly orienting a set of microwave emitters and receptors of microwave energy around such a container box, and correlating the response of the system containing the unknown material with responses to known materials, both the volume (quantity) and type (quality) of the contents can be determined.

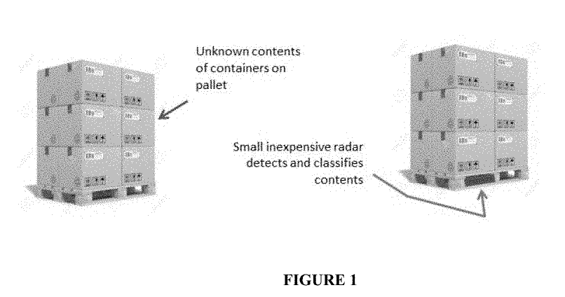

FIG. 1 shows an example of a radar product detection and inventory counting system applied to boxes on pallets. A number (5-10) of small microwave subassemblies is placed below the surface of the pallet with their antennas between the top interior deckboards. Radiation from the antennas is focused upward into the material on the pallet.

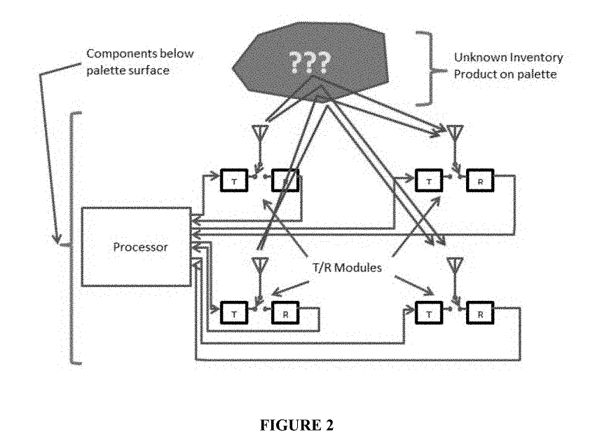

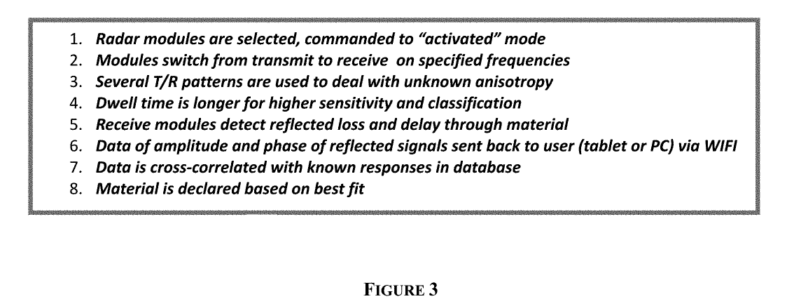

Each microwave modules consists of a transmitter and receiver (T/R) which share a common antenna through a SPDT RF switch. This allows many different paths to be selected for the microwave signals which are transmitted from beneath the pallet deck, through and reflected from the material in the boxes, and received by other microwave T/R modules also under the pallet. This is outlined in FIG. 2. This is basically a collection of bistatic radars. The highly sensitive receivers allow very low and safe microwave energy levels to be used.

The method described here is based on the fact that different materials reflect and transmit microwave energy differently. For example, a metal object will reflect much more energy than will a non-metallic object due to its much higher electrical conductivity. Similarly, non-conducting materials with high dielectric constant will reflect microwave energy more readily than materials having lower dielectric constants. There is also a frequency sensitivity to the transmission coefficients (S21) of different materials. By examining the scatter matrix of different known materials and their quantities, the system can first classify objects and their quantities on a pallet or other storage device. Each set of material and quantity will register different scatter ratios, but the scatter ratios will be similar for the same objects with same quantity. For example, a pallet that is stacked with water bottles three feet from the surface of the pallet would register a different scatter ratio than a pallet stacked with only one foot of water bottles. Once the scatter ratio is determined and stored for two feet of water bottles vs one foot of water bottles, it is then possible to measure an unknown substance on top of a pallet and based on its scatter ratio reading, compare that to the known data set and determine whether or not the quantity of the object being measured equals three feet of water bottles or two feet. Reference models of materials and quantities of interest are first measured, then manually classified and stored in a database.

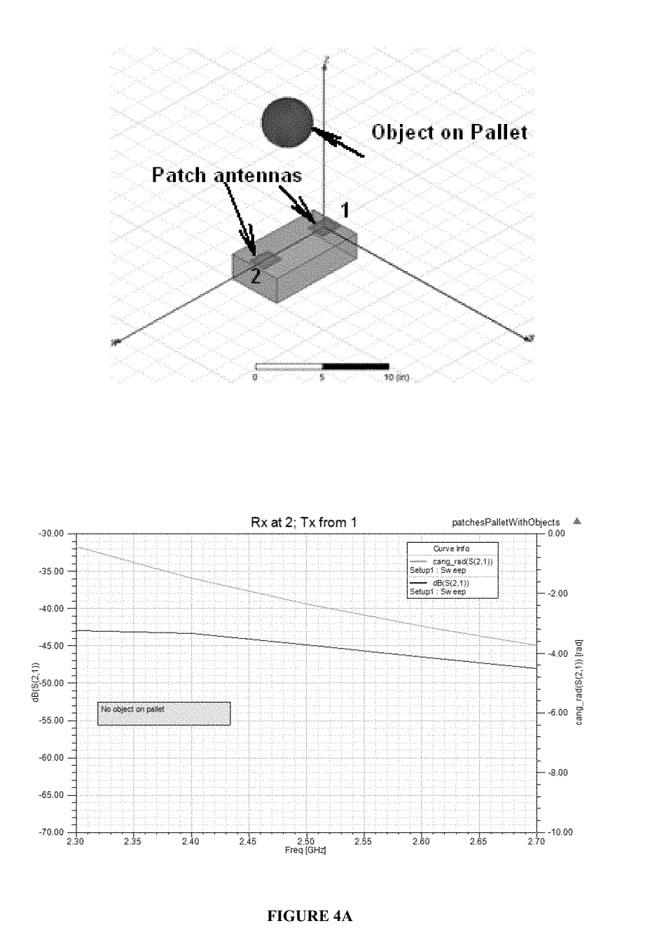

Once the database of known quantities has been built up, scatter ratios of unknown samples are first collected from the device, then either sent to a server via cellular or other connection or compared locally to cross-correlate with the known material quantity database. The quantity and material type are then determined from the highest correlation of known substances to determine an inventory level on or within the storage unit being examined. In this case there is less interest in the shape and classification of the inanimate objects as there is in medical tomography where the object of interest is a live human organ. Shape and classification in this application is used as a way to enhance the quantifying mechanism described above. Additionally, in this invention, the phase of the reflection coefficient determines the location of the detected object since delay is related to the derivative of the phase of the transmission coefficient S21. The sequence of operation is shown in FIG. 3.

The above description and scenarios refer to the reflection of emitted microwave energy off of the material in question when the measurement system is on one side of the material.

### Dual-Side Embodiment

In cases where there is access to both sides of the material in question, transmission of microwave energy through the material as well as reflection from it can be used. This adds another set of properties to be cross-correlated which will increase the accuracy and speed of the technique.

What is unique about this invention is the combination of the several data points described above (scatter matrix, S21) that can be cross-correlated and matched to previously stored templates of material to arrive at what could be described as a “volume fingerprint.” Rather than using microwave technology to only arrive at a characterization of an object (as seen in airport bag scanning machines for example) or detecting anomalies in the characteristics of known objects (medical tomography), this invention uses the microwave technology to arrive at a quantity of objects.

Simulation:

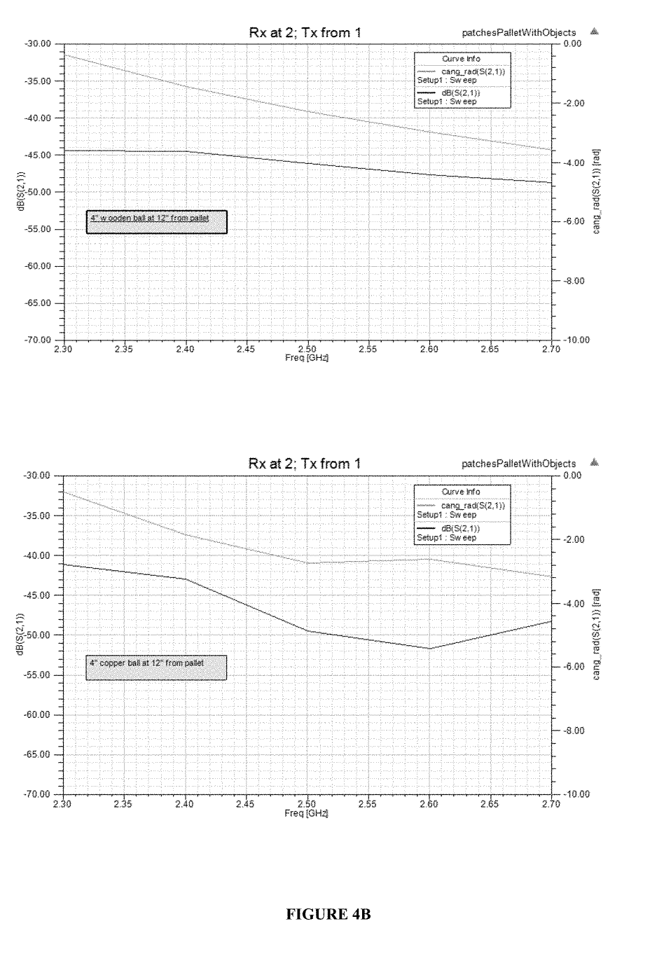

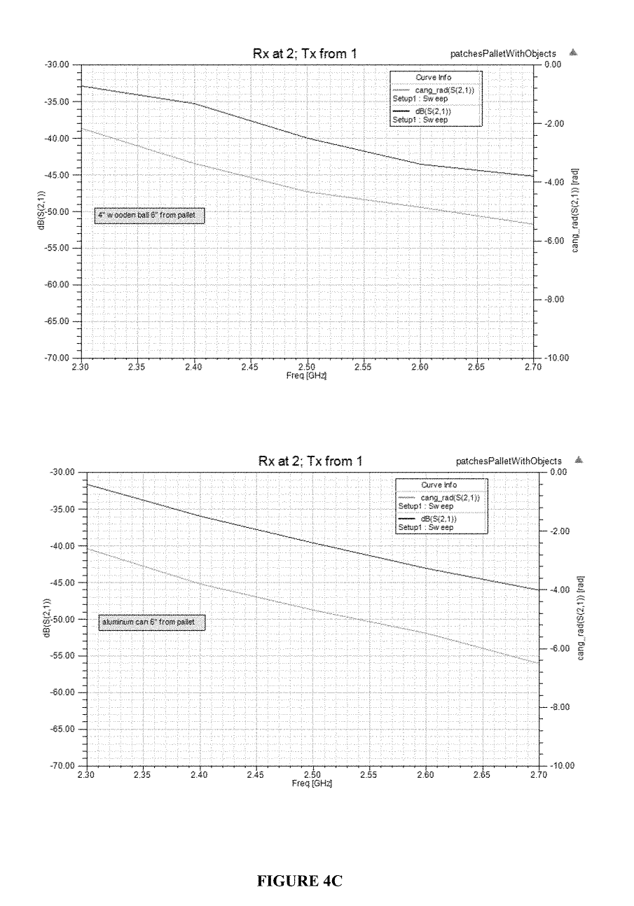

To confirm the concepts described here, a limited electromagnetic simulation was done which included a single path between two antennas located on wooden pallets. The objects in the path are spheres of different materials. As seen in FIG. 4, for a given frequency from a set of antennas, each sphere of material that is measured using this mechanism creates a different scattering matrix (e.g. a “fingerprint”). The scattering matrix for a given set and quantity of known material can be stored, thus creating a database of known quantities of certain materials. New scatter matrix readings of unknown could then be cross-correlated with the known readings and thus identified. From this information, the readings could then be transformed into structured inventory data.

Antenna Description:

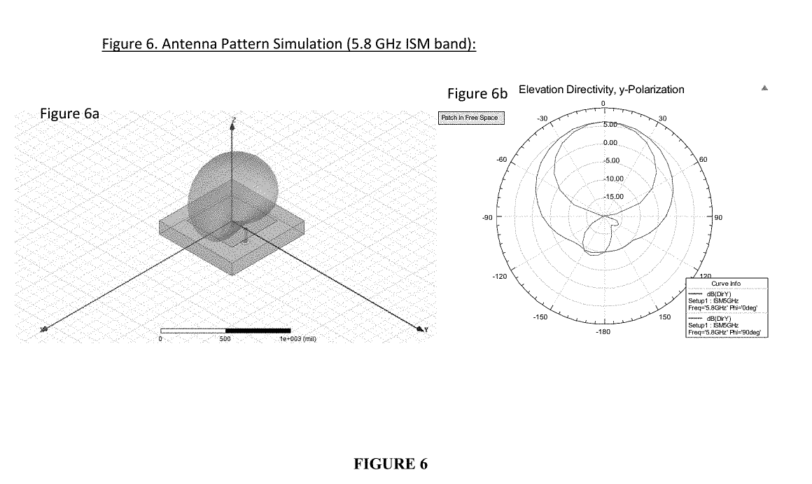

The system can comprise one transmit antenna and several receiving antennas, or many of each. The latter method of exciting and receiving different switched deployments is discussed in a further section. The individual antennas themselves are ideally flat and inserted between the floorboards of the pallet. A standard 40″×48″ pallet has six openings of 3.5″ wide by 40″ long, between the 7 top deckboards. In order to clear the forklift entry notches the maximum depth available for electronics including antennas is 2″. The individual antennas should have a beamwidth of around +/−30 degrees so the directivity will be greater than 5 dB so. Polarization control can also be used to measure the cross-pol S21 and further characterize the material on the pallet. A patch antenna, or several patches to cover the frequency range, will meet these requirements. With a maximum width of 3.5 inches the lowest frequency of operation will be around 2.0 GHz, corresponding to a half wavelength of <3 inches, as shown in FIG. 6.

Pallet-Pallet Interaction:

CDMA (Code Division Multiple Access) is an application of spread spectrum modulation which allows users of the same frequency range to coexist without interference. It is widely used on cellular networks and will be applied when required to mitigate interference between pallets. BPSK modulation will be used with a small code length since the dynamic range is not large, and processing gain need not exceed 20 dB or so. Signals will be de-spread at RF before amplitude and phase measurement.

Detection and Signal Processing:

In order to simplify the hardware, only CW is transmitted. There are also FCC rules which limit the bandwidth of radiation even within the ISM frequency bands. Simple processing at RF by detector-log-video amplifiers and phase-frequency detectors will be done up to 10 GHz.

This is not to say that there is no advantage to be gained by developing a customized modulation such as chirp or phase-coding which could more accurately and robustly perform the amplitude and phase measurements required. For example, an application for this invention in the security field is shipping containers needing to be cleared for explosives to a higher degree of probability of detection than for a commercial application. In those cases, FCC rules would not apply and all methods of obtaining radar processing gain are applicable to the waveform.

Module Reuse:

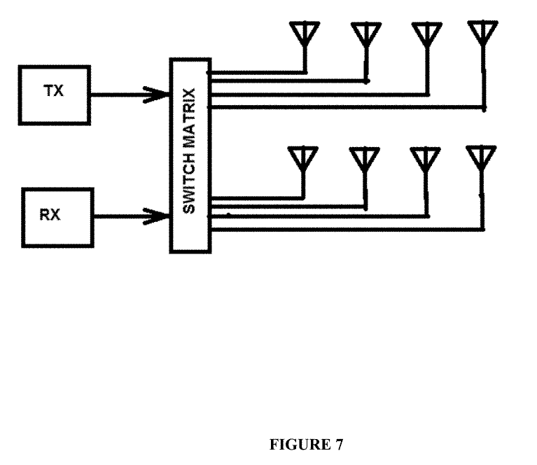

For cost and parts reduction, it is possible to multiplex a single transmitter and single receiver by switching antennas only as shown in FIG. 7. This does increase the time it takes to sample the S21 of each path but parts count of the active, expensive items is reduced greatly. The full access switch matrix multiplexes the transmitter and receiver such that equivalent measurements between all antennas are made as if each antenna had its own transmitter and receiver. Phase and amplitude variation between cables to the antennas can be calibrated out in the detection algorithm.

Ultrawideband:

So far, the methods of generating a database and cross correlating with measured responses has been used for a continuous emitter transmitting to receivers at a single frequency. Another use, producing more information can be obtained by using a wider frequency spectrum such as with a pulsed emitter. This not only increases the instantaneous bandwidth of the measurement, but allows a larger dynamic range and range resolution since the transmitter is off while receiving.

Use Cases

Pallets—

The pallet use case is largely outlined above but this section will elaborate on the utility of such an application. Once goods and materials are placed on a pallet, information about those goods is typically transferred from the manufacturer or supplier to the transporter or retailer. For example, product placed on pallets in store fronts such as lawn materials in a home & garden store or grocery products being stored in a grocery store. The manufacturer of these goods does not have knowledge of the inventory levels of the goods left on the pallet. By installing a device that utilizes the connected RF technologies outlined above, a goods manufacturer would have real-time inventory information on the status of their pallet-loaded goods whether they are in transit or being sold at a store or wholesaler. This information would then be transmitted to the cloud and accessed by the company to make a variety of more informed decisions including restocking schedule, when and how much to continue manufacture of said goods, etc.

Shelving—

A problem that is universal to all consumer packaged goods companies is knowing how much of a particular product remains on a retailer's shelves. Once the product has been delivered to a store location, the CPG has no knowledge of how much of that particular good is left on a shelf at any given time. Stores typically do not share real-time inventory data with their suppliers and the CPGs (or hired distributors) therefore often times resort to physically sending employees to the store locations to a. check on inventory levels and then b. order more of the product if necessary. In many cases, these CPG employees visit store locations several times a week to check on inventory and place orders.

In addition to the CPGs not having information regarding the levels of their product on the shelves, the stores themselves suffer from the same problem. Store employees must physically walk the aisles to see where goods have been purchased and removed from the shelves and need to be replenished from outside storage or re-arranged for aesthetic purposes.

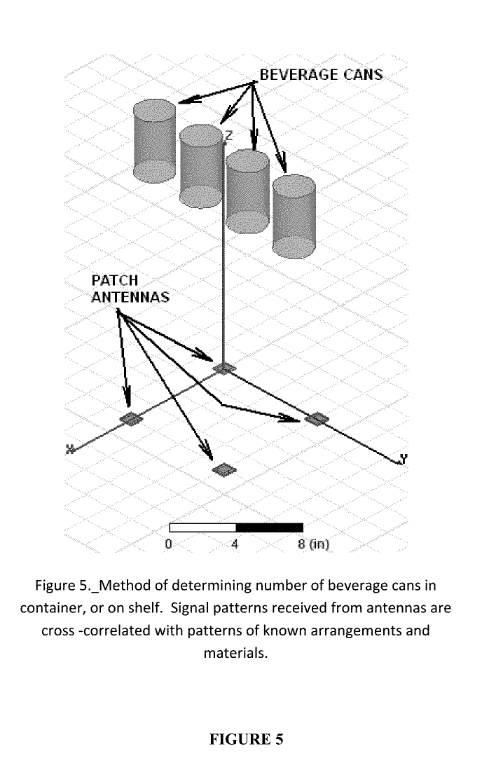

The radar arrangement outlined above can be applied to many different scenarios including a shelving one. Shelves could be lined with liners that have the transmit/receive bistatic radar circuity embedded into the liner. FIG. 5 outlines this embodiment. The invention described above could be placed into shelving systems and take inventory levels in a similar way to pallets. The set of connected RF sensors could be laid into a mat or tape that is spread out on the bottom of a shelf and utilizing the radar module reuse outlined above take quantity measurements of the product placed on top of it. This information would be sent to the cloud using either a standard cellular data transmitter or kept in the store locally for analysis. The raw RF information would be analyzed either locally or after having been sent to a cloud-based algorithm and would be accessible either by the store or the CPG company to make more informed decisions about re-ordering and restocking.

Stock Piles—

Measuring levels of stock piles of raw materials also suffers from the same problems as outlined in [0031] and [0032] herein. For example, stockpiles of mulch owned by landscaping companies or stockpiles of sand/salt used by towns or other municipalities are typically only measure by “eye-balling” the amount of material that is present. By placing antennas on the ground underneath the stockpiles, the described invention would be able to provide an accurate stockpile measurement to assist with re-ordering and inventory management. In this scenario especially, because of the large volume associated with stockpiles of raw materials, other mechanisms of measurement such as those that are optical-based or weight-based are impractical. RF-based measurement represents a significant advantage in this use case. Much like the other use cases, this data would be sent to the cloud and be accessible through a software platform.

Sea-Bearing Shipping Containers—

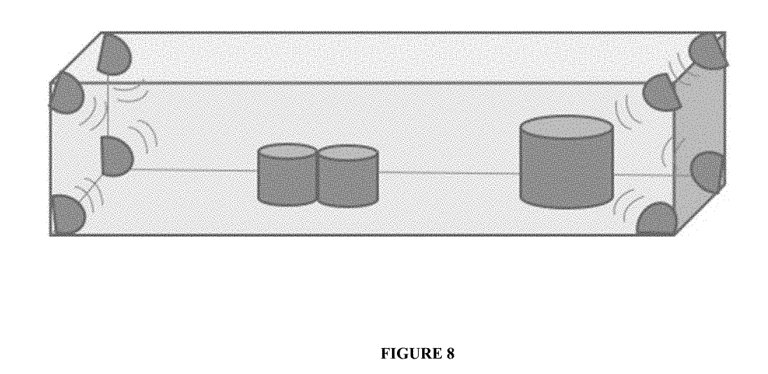

Almost all goods traded internationally travel through a sea-bearing shipping container at some point on their journey. Information about the quantity of goods or fill level of a particular container is something difficult to ascertain once the container has packed and closed. Using the RF mechanism described above, information could be transmitted about the quantity of contents of the container back to interested parties such as the shipping company or manufacturer of the goods contained within. The radar devices could either be placed on the floor of the container or in all 8 corners of the container to get a complete picture of the inside of the container. The radar devices would then be able to communicate information out via a wired or wireless connection to a transmitter device on the outside of the container. FIG. 8 outlines this embodiment.

Railroad Box Cars—

Similar to the scenario described in [0036] herein, the inventory radar system could be placed inside of railroad box cars in order to get consistent, on-demand readings on the quantity of contents of the box cars. Rather than relying on manual inspection or weight readings, which are only available at predetermined weigh stations along a railroad track, companies would have access to box car fill levels whenever needed. A set up of radars that mirrors that described in [0036] herein would allow for this. FIG. 8 outlines this embodiment.

Truck Trailers—

Similar to the scenario described in [0036] herein, the inventory radar system could be placed on inside of a truck trailer in order to determine real-time inventory or fill levels. The manufacturer of the goods contained within, the trucking company or the company receiving the goods may wish to have access to this type of information in real-time while the specified goods are in transit. FIG. 8 outlines this embodiment.

Portable Toilets—

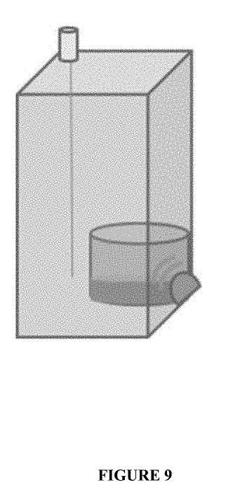

Portable toilets that are delivered on-site and the companies that regularly clean and service them would benefit greatly from having a radar-based fill-level system installed on the portable toilet. Portable toilet delivery companies have no way mechanism to ascertain the fill level of those toilets unless an actual user of the toilets contacts the company to inform them of the fill state. This leads to toilets that go untreated and/or not emptied out on time, as well as wasted trips out to the toilets for cleaning, emptying when it may not yet be necessary; causing these companies to incur undue costs. The radar device could be affixed to the outside of the toilet portion of the portable toilet and using the same technical mechanisms described above, could capture the fill level of the toilet and then using wireless cellular connection, report that fill level back to the interested party, who could then make business decisions based on those readings. FIG. 9 outlines this embodiment.

Indoor Janitorial Supplies—

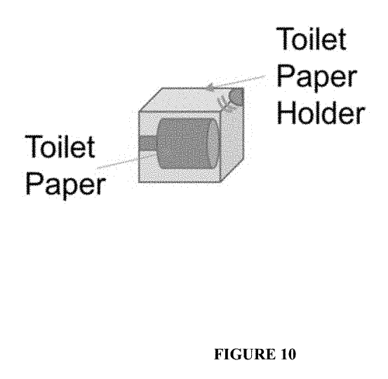

Supply level of janitorial and other supplies suffer from the same fundamental problem as the other use cases described above in that it is difficult or impossible to ascertain the quantity of material in a particular container (e.g. how much toilet paper or paper towels left on a roll) without physically viewing that material. There are several types of containers that these types of materials are stored in and the inventory radar could be aimed at these materials and transmit volume data back to a centralized system, which could then distribute alerts to janitors or other employees that refills may be necessary. This could also be applied in the portable toilet scenario as well. Building managers or others who are in charge of making sure these materials are well-stocked would then have a much more efficient way of knowing what the fill level is in real time and stop both wasteful refill trips as well as the scenario where one of these materials has run out. FIG. 10 outlines this embodiment.

Dumpster/Trash Receptacle—

The fill level of a dumpster or other trash receptacle also suffers from the same lack of information problem described in other use cases above. The owner of the dumpster company must either set up a recurring visit to empty the receptacle (when it may be not need to be emptied yet) or rely on the individuals who are using the dumpster receptacle to manually report when it is full, at which point it is too late for the company to react as the dumpster is already full. Similar to the container or truck use-case the radar system described above could placed in one or several locations within the dumpster or trash receptacle and measure the fill level and report back to the owner via a cellular or other wireless network.

Ice Merchandiser/Freezer—

Ice freezers that are typically placed in our outside of grocery or convenience stores also suffer from the same inventory knowledge shortcomings as the other use cases described above. These ice freezers are typically not refilled by the stores in which they reside but by a third party company that makes and delivers the ice. The radar device could be placed on the inside of the ice freezer, measure how full it is and transmit this information back to the ice manufacturer.

### CONCLUSION

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. A system for inventory detection of a container comprising:
a plurality of microwave modules;
the microwave modules including at least one transmitter and receiver;
the transmitter and receiver sharing a common antenna and controlled by a switch;
the microwave modules configured to transmit and receive microwave signals through the container containing one or more objects and reflected back to the microwave modules;
a processor coupled to the microwave modules configured to determine a scatter ratio based on one or more properties of the objects, including at least reflection energy;
a memory coupled to the processor for storing in a database one or more storage profiles, comprising at least the scatter ratio and associating the scatter ratio to one or more properties of the objects;
a determination by the system of the quantity and material type of the one or more objects performed by a comparison of the scatter ratio to past storage profiles; and
a communications interface coupled to the processor for transmitting the quantity and material type of the one or more objects.

2. The system according to claim 1, wherein the container is a pallet.

3. The system according to claim 1, wherein the microwave modules are located on both sides of the container whereby the transmission passes through the one or more objects.

4. The system according to claim 1, wherein the communications interface transmits real time data of the quantity and material type of the one or more objects.

5. The system according to claim 1, wherein the container is shelving.

6. The system according to claim 1, wherein the container is a railroad box car.

7. A method for inventory detection of a container comprising:
transmitting and receiving microwave signals through the container containing one or more objects with a plurality of microwave modules, and controlling the microwave modules with a switch;
determining, with a processor, coupled to the microwave modules, a scatter ratio based on one or more properties of the objects, including at least reflection energy;
storing in a database one or more storage profiles, comprising at least the scatter ratio and associating the scatter ratio to one or more properties of the objects;
determining the quantity and material type of the one or more objects performed by a comparison of the scatter ratio to existing storage profiles; and
transmitting the quantity and material type of the one or more objects.

8. The method according to claim 7, wherein the container is a pallet.

9. The method according to claim 7, wherein the microwave modules are located on both sides of the container whereby the transmission passes through the one or more objects.

10. The method according to claim 7, wherein the communications interface transmits real time data of the quantity and material type of the one or more objects.

11. The method according to claim 7, wherein the container is shelving.

12. The method according to claim 7, wherein the container is a railroad box car.
